(19) United States
(12) Patent Application Publication
(10) Pub. No.: US 2017/0159570 A1
(43) Pub. Date: Jun. 8, 2017

(54) PRESSURE REGULATING DEVICE FOR A GAS SUPPLY SYSTEM OF A GAS TURBINE PLANT

(71) Applicant: Siemens Aktiengesellschaft, Munich (DE)

(72) Inventor: Rainer Bickert, Karlstein (DE)

(73) Assignee: Siemens Aktiengesellschaft, Munich (DE)

(21) Appl. No.: 15/127,362

(22) PCT Filed: Mar. 13, 2015
(86) PCT No.: PCT/EP2015/055340

§ 371 Date: Sep. 19, 2016

(30) Foreign Application Priority Data
Mar. 31, 2014 (DE) 10 2014 205 937.2

(51) Int. Cl. F02C 7/224; F02C 9/26

(52) U.S. Cl. CPC F02C 7/224; F02C 9/263; F05D 2270/301

(57) ABSTRACT

A pressure regulating device for a gas supply system of a gas turbine plant, having a pressure reduction unit for reducing the pressure of an inflowing gas, in particular a combustion gas, a compressor system for compressing the in-flowing gas and connected in parallel to the pressure reduction unit, and a regulating valve arranged on the output side of the pressure reduction unit, via which valve the pressure reduction unit can be fluidically separated on the output side from the compressor system. A gas supply system for a gas turbine plant has a corresponding pressure regulating device and a method for pressure regulation of a gas, uses a gas supply system with a corresponding pressure regulating device.

### CROSS REFERENCE TO RELATED APPLICATIONS

This application is the US National Stage of International Application No. PCT/EP2015/055340 filed Mar. 13, 2015, and claims the benefit thereof. The International Application claims the benefit of German Application No. DE 102014205937.2 filed Mar. 31, 2014. All of the applications are incorporated by reference herein in their entirety.

### FIELD OF INVENTION

The invention relates to a pressure-regulating device for a gas supply system of a gas turbine plant. The invention moreover relates to a gas supply system for a gas turbine plant and to a method for regulating the pressure of a gas.

### BACKGROUND OF INVENTION

A gas turbine is used as part of a gas turbine plant for generating electricity by burning gaseous fuels such as, for example, natural gas. The gas turbine is hereby operated by means of the fuel and itself drives one or more generators. The inlet pressure of the natural gas needs in particular to be taken into account when using natural gas flows to operate a gas turbine. Because the places where fuel gas is extracted are usually far removed from the location of the consumer, corresponding delivery is required. For this purpose, the fuel gas is first compressed to high transportation pressures and the pressure of the gas is set to the required inlet pressure value only at the respective consumption site. This inlet pressure is frequently not constant and fluctuates instead.

In order to overcome this problem, it is current practice to use pressure-regulating devices which are capable of keeping the pressure of the fuel gas within predetermined limits, independently of the fluctuations in the inlet pressure, in one or more control loops. An operating pressure within a range from 36 bar to 40 bar is, for example, required to operate a gas turbine.

Concepts from the prior art hereby provide to equip a pressure-regulating device for supplying gas to a gas turbine plant with two control systems connected in parallel. One of the control systems is designed as a pressure-reduction unit which restricts the pressure of the inflowing fuel gas to a preset value. A compressor unit is used as the second control system which serves to compress the fuel gas and by means of this the pressure of the fuel gas can be raised again when needed, i.e. when an undesired drop in pressure can be expected or has already been recorded. By combining both control systems it is possible to set the required operating pressure at the inlet to the gas turbine for all gas inlet conditions.

Whilst both the pure reduction mode of a pressure-regulating device, i.e. operation of just the pressure-reduction unit in the event of high inlet pressure of an inflowing fuel gas, and the pure compression mode, i.e. operation of just the compressor unit in the event of low inlet pressure of the inflowing fuel gas, can be managed relatively easily, the design of the switching phase between the two control systems has to date been problematic. Because the control systems connected in parallel work in a common collector, they influence each other during the switching phase, i.e. when a switch is made between the reduction mode and compression mode.

During the process of switching from the pressure-reduction unit to the compressor unit, the latter can thus only ensure the desired compression of the fuel gas when it is capable of “overpowering” the pressure-reduction unit or suppressing the reduction mode. During the reverse switching process, the pressure-reduction unit can only resume operation when there is no longer any compressor pressure exerted by the compressor unit.

However, as well as maintaining a regulated inlet pressure, a gas turbine also provides a limiting of the pressure gradients in the inlet system. A pressure-regulating device for a gas supply system of a gas turbine must therefore be designed in such a way that pressure surges are avoided in particular during the switching process.

In conventional pressure-regulating devices, shut-off valves and own medium-actuated control valves, which interact in a suitable fashion during the switching phase, are therefore associated with the control systems, i.e. in particular with the compressor unit and the pressure-reduction unit. For example, a motor-driven shut-off valve can be provided at the outlet side of the compressor unit, wherein the pressure at the outlet side of the compressor unit acts as an outlet pressure on own medium-actuated control valves used in the pressure-reduction unit. When a switch is made from the reduction mode to the compression mode, the shut-off valve is opened, while the control valves close owing to the outlet pressure which is now elevated. Conversely, the control valves open when the shut-off valve of the compressor unit closes. The system dynamics are then determined by the response times of the shut-off valves and the control valves and can be optimized only by selecting suitably available valves. However, it is not possible to claim a regulated or constant pressure gradient during the switching phase.

Moreover, in the case of an abovedescribed pressure-regulating device it is still necessary to select the pressure setting of the compressor unit to be higher than the pressure setting of the pressure-reduction unit. The required pressure difference is hereby calculated essentially from the device parameters of the armatures used in the pressure-reduction device. The required pressure setting of the compressor unit is approximately 3 to 4 bar above the pressure setting of the pressure-reduction unit. As a result of this excessively elevated pressure, in the switching phase the reduction unit can be shut down (the control valves close) and thus an operating pressure of a suitable level which is sufficiently stable for the operation of the gas turbine plant can be ensured in the inlet system.

However, as a result of the required difference in pressure of approximately 3 to 4 bar between the setting of the pressure-reduction unit and the setting of the compressor unit, the fuel gas in the compressor unit is in principle compressed to a pressure which is higher than would be necessary for operation of a gas turbine plant. The compressor unit needs to be designed for a pressure which is 3 to 4 bar above the actual required operating pressure of the gas turbine.

### SUMMARY OF INVENTION

A first object of the invention is accordingly to provide a pressure-regulating device for a gas supply system of a gas turbine plant which is improved compared with the prior art.

A second object of the invention is accordingly to provide a gas supply system with a corresponding pressure-regulating device.

A third object of the invention is to provide a method for regulating the pressure of a gas, in particular a fuel gas, which makes use of the advantages of the improved pressure-regulating device.

The first object of the invention is achieved according to the invention by a pressure-regulating device for a gas supply system of a gas turbine plant which comprises a pressure-reduction unit for reducing the pressure of an inflowing gas, in particular a fuel gas, a compressor unit, connected in parallel to the pressure-reduction unit, for compressing an inflowing gas, and a control armature arranged on the outlet side of the pressure-reduction unit, via which the pressure-reduction unit can be separated fluidically from the compressor unit on the outlet side.

In a first step, the invention is based on the fact that, owing to the pressure difference required during the switching phase between the setting of the compressor unit and the setting of the pressure-reduction unit, unnecessarily high compressor power is required, which entails unnecessary extra costs and undesirably increases the energy required to operate a pressure-regulating device.

In a second step, the invention is based on the consideration that the excessively elevated pressure which has to date been required for the compressor unit can be omitted if the mutual influencing of the control systems used to regulate pressure, i.e. the pressure-reduction unit and the compressor unit, is prevented during the switching phase.

In a third step, the invention recognizes that this is possible by being able to fluidically separate the control systems, which separability can be implemented simply and effectively by integrating a control armature arranged at the outlet side of the pressure-reduction unit into the pressure-regulating device. As a result of such an armature, the pressure-reduction unit can, when required, be sealed off from the compressor unit at the outlet side.

During the switching phase from the reduction mode to the compression mode, the pressure can be reduced slowly and in a controlled fashion at the outlet side of the pressure-reduction unit, and the first control system (pressure-reduction unit) can be sealed off from the second control system (compressor unit) in compression mode. As a result, it is achieved that the compressor unit does not need to suppress the function of the pressure-reduction unit in particular in the switching phase, so that the compression pressure can overall be set lower than previously.

Owing to the lower required outlet pressure of the compressor unit, a lower compressor power is required, as a result of which the operating costs of the compressor unit can be reduced. According to rough calculations, the drive power of the compressor unit is reduced by approximately 300 kW, based on typical consumption of the gas turbine plant of 16 kg/s at an inlet pressure of approximately 20 bar and a final pressure of 30 to 40 bar, with the compressor setting reduced by 3 bar.

It is thus possible, for example, to omit one compressor stage in a multi-stage compressor unit.

Furthermore, there is no longer a need for any specific non-return outlet pres sure-resistant control armatures which have been used to date as control armatures in the compressor unit and the pressure-reduction unit. Because the pressure-reduction unit can be completely separated from the remainder of the system by arranging the control armature on the outlet side during the operation of the compressor unit, it is now possible to fall back on more cost-effective and simpler-to-handle control armatures.

The controlled switching from the reduction mode to the compression mode, and vice versa, can be regulated simply by selecting suitable closing and opening rules in order to actuate the control armature, i.e. via the pressure gradients in the downstream pipe system. To do this, the control armature is controlled correspondingly via an actuating drive. In other words, during the switching phase the control armature enables the pressure gradients to be set in the downstream pipe system, i.e. on the outlet side of the compressor unit and the pressure-reduction unit.

In a development of the pressure-regulating device, the pressure-reduction unit and the compressor unit lead on the outlet side into a common collection line via a T-junction branching piece, wherein the control armature is arranged between the pressure-reduction unit and the T-junction branching piece. At this location, during a switching phase it is possible to achieve the separation of the pressure-reduction unit from the compressor unit in a technically relatively simple and manageable fashion, whilst maintaining the predetermined pressure gradients.

In an advantageous embodiment of the invention, the pressure setting in the compressor unit corresponds essentially to the pressure setting in the pressure-reduction unit. If the pressure-reduction unit is designed with a main control loop and a secondary control loop, the pressure setting in the compressor unit in particular corresponds to the lowest pressure setting in the pressure-reduction unit, i.e. to the predetermined value for the secondary control system. In other words, the final pressure of the compressor unit is at the pressure level of the pressure-reduction unit, and the setting of a pressure difference between the two control systems which has been required to date can be dispensed with by the integrated control armature.

The control armature is advantageously designed as a control ball valve. Control ball valves are particularly suited for small differences in pressure, as can prevail in the switching phase between the pressure-reduction unit and the compressor unit. The loss of pressure of a control ball valve when open is virtually zero.

The pressure-reduction unit in particular comprises two redundant pressure control loops connected in parallel. One of the pressure control loops is here advantageously used as a main control system, and the other pressure control loop is used as a secondary control system. For this purpose, the secondary control system is set to a pressure value which is lower than the pressure setting of the main control system. As long as the main control system is working properly and there is no other fault in the main control loop, the outlet pressure is within a range in which the secondary control system remains closed, for example via own medium-actuated control valves inserted therein. If the outlet pressure falls, the secondary control system with own medium-actuated control valves opens automatically. In other words, in an embodiment the two control loops are configured so that they are staggered relative to each other, wherein the pressure settings differ.

The second object of the invention is achieved according to the invention by a gas supply system for a gas turbine plant, comprising a gas feed, an abovedescribed pressure-regulating device coupled fluidically to the gas feed, and a feed line to the gas turbine plant, coupled fluidically to the pressure-regulating device.

By means of controlled switching between the pressure reduction of a fuel gas in reduction mode and the compression of a fuel gas in compression mode, the gas supply system provided enables a fuel gas to be permanently provided at a suitable pressure level for combustion in a gas turbine plant at a relatively low cost and with a relatively low expenditure of energy.

A processing stage is in particular incorporated in the gas feed, and a post-processing stage in the feed line to the gas turbine plant. The processing and post-processing stages serve to process the fuel gas correspondingly, for example in terms of its temperature or in terms of the content of foreign particles, for the pressure-regulating device and for the gas turbine plant.

In an advantageous embodiment, the processing stage comprises a filter unit and/or a preheating unit. The processing stage is connected upstream from the pressure-regulating device. The filter unit hereby serves to preclean the fuel gas, for example by removing undesired particles. In the preheating unit, which is advantageously fluidically connected downstream from the filter unit, the precleaned fuel gas is preheated in order to avoid condensation during expansion and lastly is fed to the pressure-reduction unit and the compressor unit in order to set the desired pressure of the pressure-regulating device.

Once it has passed the pressure-regulating device, the fuel gas is fed to a post-processing stage connected downstream from the pressure-regulating device. The post-processing stage also comprises a filter unit and/or a preheating unit. After pressure regulation, the fuel gas is processed (or post-processed) again and for this purpose subjected to a further cleaning and heating, wherein, in the case of post=processing, the final cleaning in the filter unit advantageously takes place after the preheating. In addition, in the preheating unit the efficiency of the gas turbine plant can be influenced and the Wobbe index, i.e. the ratio between the heating value and the square root of the specific gravity, can be set.

The further advantages mentioned for the pressure-regulating device and its advantageous developments can be transferred correspondingly to the gas supply system.

The third object of the invention is achieved according to the invention by a method for regulating the pressure of a gas, in particular a fuel gas of a gas turbine plant, wherein the gas is fed to a pressure-reduction unit and/or to a compressor unit connected in parallel with the latter, wherein the gas is guided via the pressure-reduction unit in the reduction mode, wherein the gas is guided via the compressor unit in the compression mode, and wherein a control armature separating the pressure-reduction unit on the outlet side from the compressor unit is actuated during a switching phase between reduction mode and compression mode.

By means of such a method, it can be ensured that the predetermined threshold values for pressure values and for pressure gradients are maintained during a switching phase between reduction mode and compression mode. For this purpose, the control armature is actuated during the switching phase using corresponding opening or closing rules, such that the pressure-reduction unit and the compressor unit interact in a specific and defined fashion in the common collector or are fluidically connected to or separated from the latter. The provision of the control armature makes it possible in particular to operate the compressor unit at a pressure setting which corresponds to the minimum pressure setting of the pressure-reducing unit, in respect of which reference is made to the corresponding embodiments of the pressure-regulating device.

When fuel gas is fed into an abovedescribed pressure-regulating device, it flows through a pressure-reduction unit and/or through a compressor unit connected in parallel hereto. Inside the pressure-reduction unit, the inflowing fuel gas is reduced to a preset pressure value. In the case of undesired reduction of the plant inlet pressure below the predetermined value, the compressor unit is started up in order to raise the pressure again to a pressure setting which has been predetermined for the compressor unit. Correspondingly, when the plant inlet pressure is raised, a switch is made from compression mode back to reduction mode. During a switching phase between compression mode and reduction mode, as already described the two control systems influence each other in an undesired fashion, which can be avoided by use of the control armature.

In an advantageous development, the control armature is closed during a switching phase from reduction mode to compression mode and remains closed during compression mode. More advantageously, the control armature is opened during a switching phase from compression mode to reduction mode and remains open during reduction mode. The control armature is advantageously actuated during the switching phases in order to maintain a predetermined range of the pressure gradients in the downstream pipe system.

As a consequence of the actuation of the control armature during a switching phase, the excessive elevation of the pressure by the compressor unit can be omitted. The pressure of the compressor unit is in particular set correspondingly to a value that corresponds essentially to the minimum pressure value of the gas which has had its pressure reduced in the pressure-reduction unit.

The gas is advantageously processed in a processing stage before it enters the pressure-regulating unit. The processing stage advantageously comprises a filter unit and/or a preheating unit.

More advantageously, the gas exiting the pressure-regulating device is fed to a post-processing stage. The latter advantageously also comprises a filter unit and/or a preheating unit. After it has passed the post-processing stage, the gas is then advantageously fed to a gas turbine plant via a feed line.

### BRIEF DESCRIPTION OF THE DRAWINGS

Exemplary embodiments of the invention are explained in detail below. In the drawings:

FIG. 1 shows a pressure-regulating device as part of a gas supply system of a gas turbine plant, and

FIG. 2 shows a gas supply system with the pressure-regulating device according to FIG. 1.

### DETAILED DESCRIPTION OF INVENTION

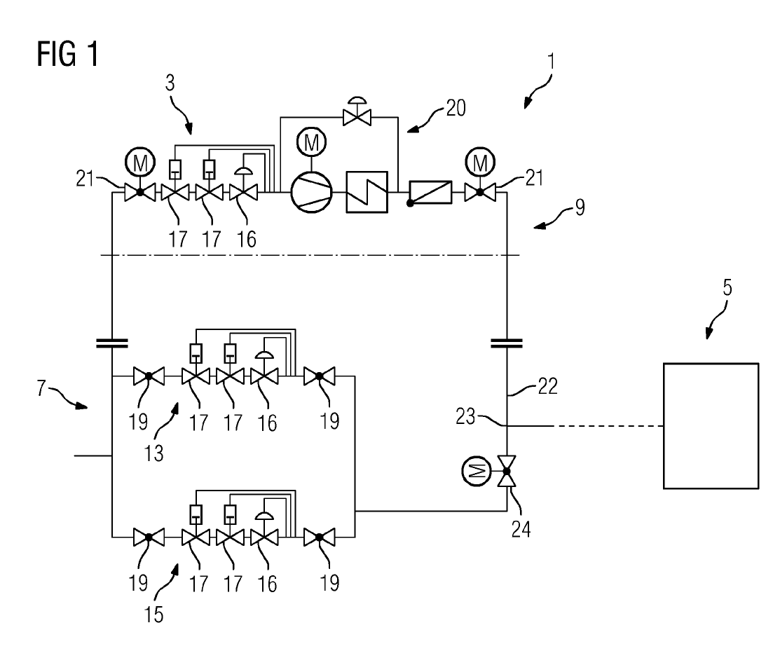

FIG. 1 shows a pressure-regulating device 1 as part of a gas supply system 3 for a gas turbine plant 5. The pressure-regulating device 1 comprises a first control system, namely a pressure-reduction unit 7, and a second control system, namely a compressor unit 9, which are connected in parallel to each other.

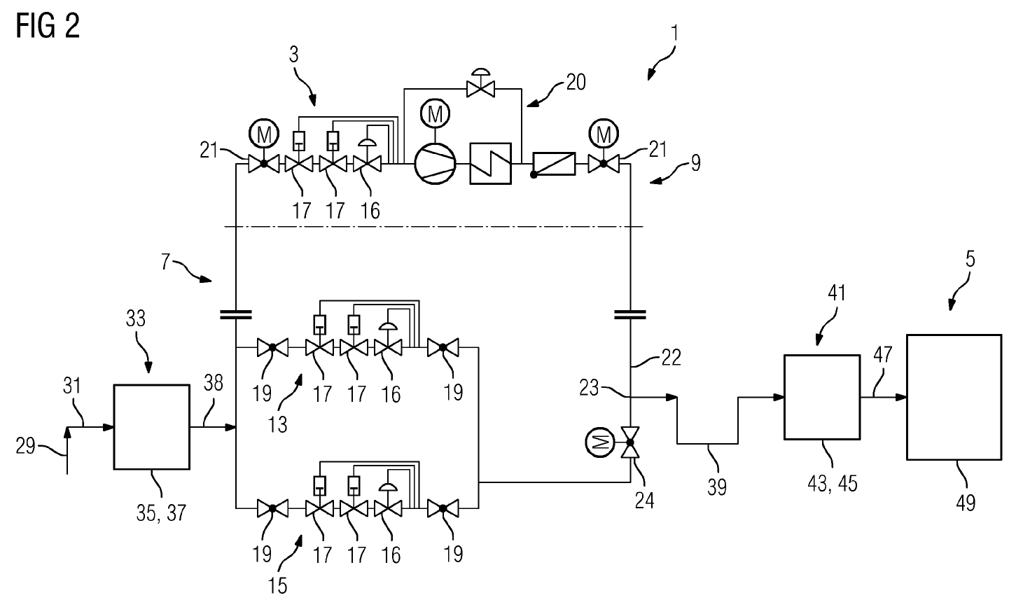

In order to set the pressure of the fuel gas, the latter is fed to the pressure-reduction unit 7 after a corresponding processing which will be explained in detail subsequently with reference to FIG. 2.

The pressure-reduction unit 7 comprises two pressure control loops 13, 15 connected in parallel, each of which comprise in particular an own medium-actuated control valve 16, two safety shut-off valves 17 and two manually actuatable shut-off armatures 19. In the present case, the pressure setting of the first pressure control loop 13 is set, for example, to a value of 36 bar and the pressure setting of the second pressure-reduction stage 15 is set to a value of 35 bar. Accordingly, the first pressure control loop 13 works as a main control system and the second pressure control loop 15 as a secondary control system. In normal operation, the own medium-actuated control valves 16 of the second control loop 15 remain closed owing to the higher outlet pressure caused by the first control loop 13.

The compressor unit 9 comprises a compressor part 20, an own medium-actuated control valve 16, two safety shut-off valves 17, and two motor-actuated shut-off armatures 21. The compressor unit 9 is set to a pressure setting which corresponds to the pressure setting of the second control loop 15 of the pressure-reduction unit 7, in the present case therefore 35 bar.

The compressor unit 9 and the pressure-reduction unit 7 deliver on the outlet side into a common collector 22. The collector 22 is connected to the gas turbine plant 5 via a T-junction branching piece 23.

If the plant inlet pressure falls below a threshold pressure below which a reduction mode is no longer possible, the compressor unit 9 is switched on by opening the motor-driven shut-off armatures 21. The pressure-reduction unit 7 must be shut down. In order to achieve a defined pressure value on the outlet side in this switching phase without any pressure surges, a control armature 24 arranged between the pressure-reduction unit 7 and the T-junction branching piece 23 is closed according to predetermined closing rules. This control armature 24 remains closed during the compression mode.

Conversely, in a switching phase from compression mode to pressure-reduction mode, the control armature 24 is opened according to predetermined opening rules, whilst the motor-driven shut-off valves 21 are closed, and remains open during the pressure-reduction mode.

A gas supply system 3 with the pressure-regulating device 1 according to FIG. 1 is shown in FIG. 2. For operation of the gas turbine plant 5, starting from a pipeline 29, a fuel gas, in the present case natural gas, is fed to a processing stage 33 via a gas feed 31 designed as a feed line. The processing stage 33 comprises a filter unit 35 and a preheating unit 37. The natural gas is cleaned in the filter unit 35 and lastly preheated in the preheating unit 37 connected downstream from the filter unit 35.

The natural gas is then fed to the pressure-regulating device 1 via a further feed line 38 in order to set the desired pressure. As described in detail in FIG. 1, the pressure of the natural gas in the pressure-reduction unit 7 is here reduced and/or compressed to the desired pressure in the compressor unit 9.

After it has passed the pressure-regulating device 1, the natural gas is fed to a post-processing stage 41 via a feed line 39. In the post-processing stage 41, the natural gas is preheated again in a preheater 43 and then fed to a further filter unit 45 for final cleaning. Exiting the filter unit 45, the natural gas is then fed to a gas turbine 49 of the gas turbine plant 5 via a feed line 47 and can be used there to generate electrical energy.

1. A pressure-regulating device for a gas supply system of a gas turbine plant, comprising
a pressure-reduction unit for reducing the pressure of an inflowing gas,
a compressor unit, connected in parallel to the pressure-reduction unit, for compressing an inflowing gas, and
a control armature arranged on the outlet side of the pressure-reduction unit, via which the pressure-reduction unit is separable fluidically from the compressor unit on the outlet side.

2. The pressure-regulating device as claimed in claim 1,
wherein the pressure-reduction unit and the compressor unit lead on the outlet side into a common collection line via a T-junction branching piece, and wherein the control armature is arranged between the pressure-reduction unit and the T-junction branching piece.

3. The pressure-regulating device as claimed in claim 1,
wherein the pressure setting in the compressor unit corresponds essentially to the pressure setting in the pressure-reduction unit.

4. The pressure-regulating device as claimed in claim 1,
wherein the pressure-reduction unit comprises two pressure control loops connected in parallel.

5. The pressure-regulating device as claimed in claim 3,
wherein the pressure control loops of the pressure-reduction unit are each set to different pressure values.

6. A gas supply system for a gas turbine plant, comprising
a gas feed,
a pressure-regulating device as claimed in claim 1, coupled fluidically to the gas feed, and a feed line to the gas turbine plant, coupled fluidically to the pressure-regulating device.

7. The gas supply system (3) as claimed in claim 6,
wherein a processing stage is connected in the gas feed, and a post-processing stage in the feed line to the gas turbine plant.

8. The gas supply system as claimed in claim 7,
wherein the processing stage comprises a filter unit and/or a preheating unit.

9. The gas supply system as claimed in claim 7,
wherein the post-processing stage comprises a filter unit and/or a preheating unit.

10. A method for regulating the pressure of a gas, of a gas turbine plant, the method comprising:
feeding the gas to a pressure-reduction unit and/or to a compressor unit connected in parallel with the latter,
guiding the gas via the pressure-reduction unit in a reduction mode,
guiding the gas via the compressor unit in a compression mode, and
actuating a control armature separating the pressure-reduction unit on the outlet side from the compressor unit during a switching phase between reduction mode and compression mode.

11. The method as claimed in claim 10,
wherein the control armature is closed during a switching phase from reduction mode to compression mode and remains closed during compression mode and/or wherein the control armature is opened during a switching phase from compression mode to reduction mode and remains open during reduction mode.

12. The method as claimed in claim 10,
wherein the pressure setting inside the compressor unit is set to a value that corresponds essentially to the pressure setting of the gas which has had its pressure reduced in the pressure-reduction unit.

13. The method as claimed in claim 10,
wherein the gas is processed in a processing stage before it enters the pressure-regulating device.

14. The method as claimed in claim 10,
wherein the gas exiting the pressure-regulating device is fed to a post-processing stage.

15. The method as claimed in claim 10,
wherein the gas exiting the post-processing stage is fed to a gas turbine plant via a feed line.

16. The method as claimed in 10,
wherein the gas comprises a fuel gas.

17. The pressure-regulating device as claimed in 1,
wherein the gas comprises a fuel gas.
